(19) United States
(12) Patent Application Publication
(10) Pub. No.: US 2007/0170786 A1
(43) Pub. Date: Jul. 26, 2007

(54) Moving-magnet-type linear slider

(76) Inventors: Yasuhiro Miyamoto, Fukuoka (JP); Shirou Ohga, Fukuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/593,470

(22) PCT Filed: Mar. 7, 2005
(86) PCT No.: PCT/JP05/03885

§ 371 Date: Sep. 19, 2006

(30) Foreign Application Priority Data
Mar. 19, 2004 (JP) 2004-081219

(51) Int. Cl. H02K 41/00

(52) U.S. Cl. 310/12

(57) ABSTRACT

A moving-magnet-type linear slider is constructed with a linear guide that movably supports and guides a table (3) with respect to a fixed base (1), a linear motor in which a permanent magnet (4) for a magnetic field is arranged on a table (3) side and an armature (2) is arranged on the fixed base (1), and detecting means in which a linear scale (5) is fixed on the table (3) and a sensor head (6) is fixed on a fixed base (1) side. When fixing the armature (2) on the fixed base (1) so as to be sandwiched between left and right guide rails (8) on the fixed base (1), a thrust center axis where a trust of the armature (2) is generated is arranged so as to be substantially coincident with a center axis G-G of a space between the left and right guide rails (8).

### TECHNICAL FIELD

The present invention relates to a linear motor used in various industrial machines such as an electronic component mounting apparatus, a semiconductor-related apparatus or machine tools and suitable for driving the direct-driven mechanisms thereof and, in particular, relates to a moving-magnet-type linear slider including a magnetic field of a permanent magnet as a mover and an armature having an armature winding as a stator.

### BACKGROUND ART

Conventionally, the moving-magnet-type linear slider, which is used in various industrial machines such as an electronic component mounting apparatus, a semiconductor-related apparatus or machine tools and suitable for driving the direct-driven mechanisms thereof, is constructed as shown in FIG. 6. FIG. 6 is a front sectional view of a moving-magnet-type linear slider showing a conventional art.

In FIG. 6, 31 is a mover, 32, 33 are permanent magnet units, 34 is a split core, 35 is an armature unit, 36 is a stator, 37 is a stator frame, 38 a is fixed member, 39 is a table, 40 is a guide rail, and 41 is a slider.

The mover 31 of the linear motor includes the permanent magnet units 32, 33 extending in a vertical direction and in which permanent magnets for a magnetic field are juxtaposed to each other on a lower surface of the table 38. The stator 36 includes a fixed member 38 made of iron in an W-shape and fixed on a box-shaped stator frame 37, and an armature unit 35 secured on an inner side of the fixed member 38 by, for example, an adhesive. The armature unit 35 is constituted by a concentrated winding of an armature winding wire wound on the split core 34, the armature winding wire being provided such that the permanent magnet unit is sandwiched between the armature winding wires from both sides. Meanwhile, the mover 31 is slidably supported by a linear guide having a guide rail 40 and a slider 41 (for example, see Patent document 1).

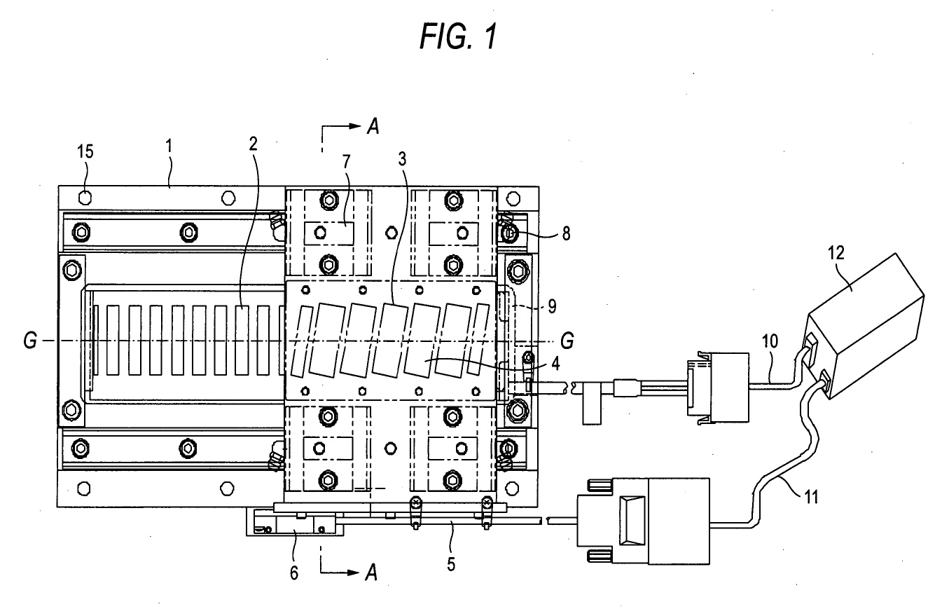

Patent Document 1: JP-A-11-113238 (FIG. 1).

### DISCLOSURE OF THE INVENTION

### Problems to be Solved by the Invention

However, in the conventional moving-magnet-type linear slider, the fixing of the permanent magnet to the table has a structure in which only one end of the magnet extending in the vertical direction is fixed. Thus, there is a problem that a mechanical rigidity of a thrust-generating region of the mover is weak because of the structure that cannot be fixed at both ends.

Meanwhile, in the conventional structure in which attractive forces are canceled each other, there is also a problem that a control gain cannot be raised since the linear guide is not applied with a pressurization of a magnetic attractive force and the mechanical rigidity is weakened.

The present invention has been made in view of such problems, and it is an object thereof to provide a moving-magnet-type linear slider that can strengthen the rigidity by suitably applying a pressurization of a magnetic attractive force to the linear guide.

### Means for Solving the Problem

In order to solve the problem, the present invention is structured as in the following.

The invention directed to a moving-magnet-type linear slider according to claim 1 is a moving-magnet-type linear slider having a linear guide which movably supports and guides left and right sides of a table arranged parallel with and opposite to a fixed base wherein the linear guide includes a slider and a guide rail, a linear motor which reciprocally moves the table in a longitudinal direction over the guide rail relative to the fixed base, and detecting means for detecting a relative position of the table and the fixed base, characterized in that the linear motor comprises an armature having an multi-phase armature winding wire wound on an armature core serving as a magnetic circuit fixed on the fixed base, and a permanent magnet for a magnetic field, the permanent magnet being attached on the table and arranged opposite to the armature interposing a magnetic gap, the detecting means comprises a linear scale portion fixed to the table, and a sensor head portion which detects the linear scale, the a sensor head portion being attached on a fixed base side, and the armature is arranged such that a thrust center axis where a thrust of the armature is generated is substantially coincident with a center axis of a space between the left and right guide rails.

The invention according to claim 2 is characterized in that, in a moving-magnet-type linear slider according to claim 1, a magnetic-pole detector which detects a relative position of the armature and the permanent magnet for a magnetic field is structurally arranged on a opposite side of the linear scale, wherein a hall element constituting a part of the magnetic-pole detector is fixed on the fixed base side, and a magnetic-pole detector permanent magnet constituting another part of the magnetic-pole detector is fixed on the table side so as to have an equal pitch as the permanent magnet for a magnetic field.

The invention according to claim 3 is characterized in that, in a moving-magnet-type linear slider according to claim 1, the fixed base is provided with a mounting hole for attaching to an external apparatus in a position outside or inside of the guide rail.

The invention according to claim 4 is characterized in that, in a moving-magnet-type linear slider according to claim 1, the sensor head incorporates a circuit which converts a magnetic-pole-detection signal and a scale signal of the linear motor into serial signals.

The invention according to claim 5 is characterized in that, in a moving-magnet-type linear slider according to claim 1 or 4, the sensor head has a memory into which a motor parameter of the linear motor is input, wherein, when the linear slider and a driver are connected together, the motor parameter is also converted into a serial signal by the serial-signal conversion circuit, thus providing a contrivance to transmit the signal to the driver.

The invention according to claim 6 is characterized in that, in a moving-magnet-type linear slider according to claim 1, the linear scale mounts thereon an absolute-type encoder which detects an absolute position signal of the linear-motor mover.

### Effect of the Invention

According to the invention set forth in claims 1 and 6, pressure can be exerted to the linear guide by a magnetic attractive force of the permanent magnet for a magnetic field, and one surface of the field permanent magnet is firmly fixed on a mover table. Accordingly, design with high mover rigidity as well as high guide rigidity due to a linear guide pressurization is possible.

According to the invention of claim 2, the provision of the magnetic-pole detector makes it possible to immediately detect a relative position of the linear armature and the permanent magnet for a magnetic field when turning on a servo, and thus simplifying a setup.

According to the invention of claim 3, design is possible with small slider width by forming a mounting hole for a user.

According to the invention of claims 4 and 5, a structure is provided so as to serial-transmit a motor parameter, in which information such as a motor constant is previously stored in a linear slider, and by inputting a driver parameter information to the driver when connected to a driver, immediate restoration to the previous status is possible when exchanged with another driver in case where a driver is exchanged due to a failure in the future.

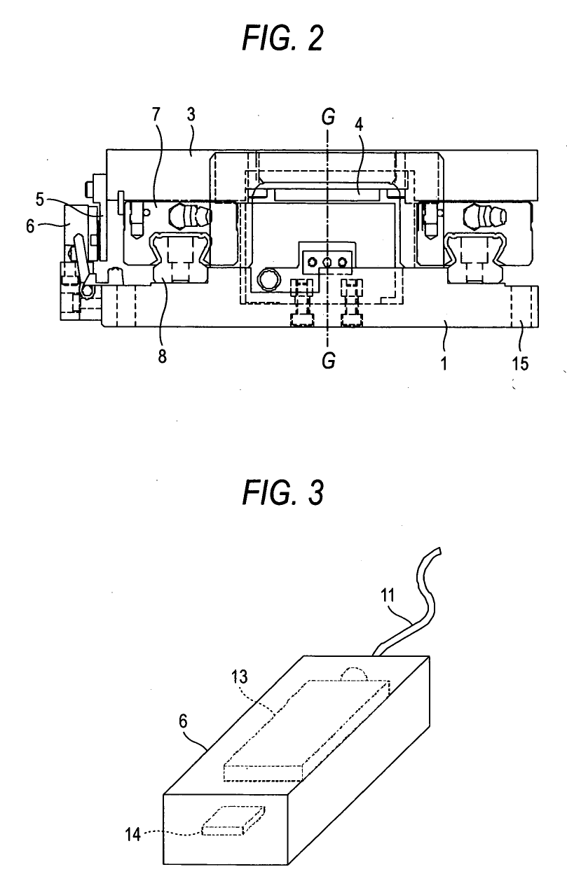

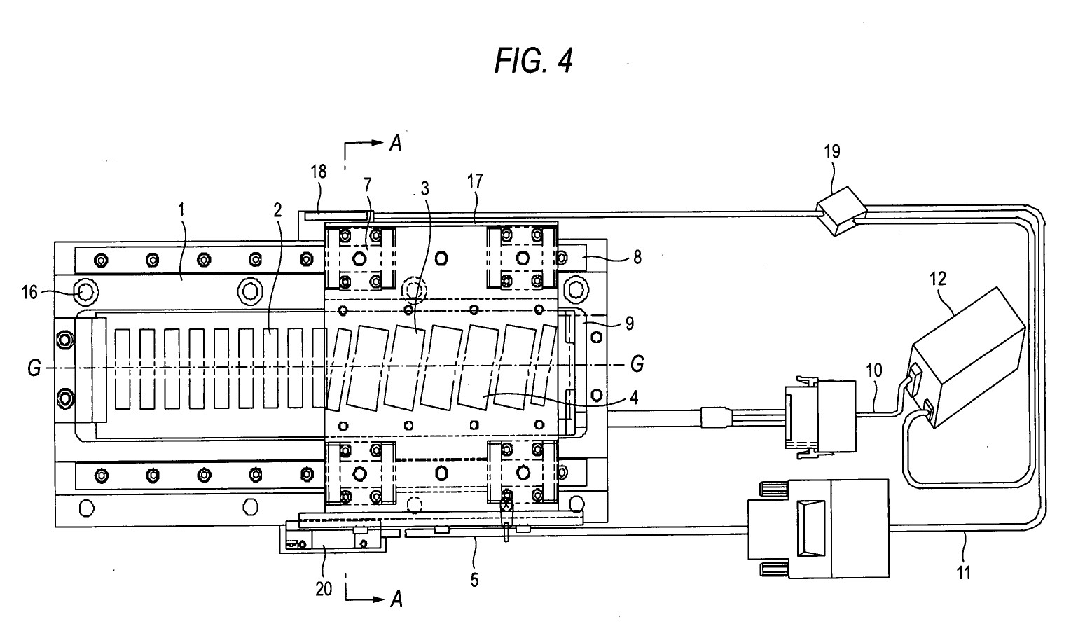

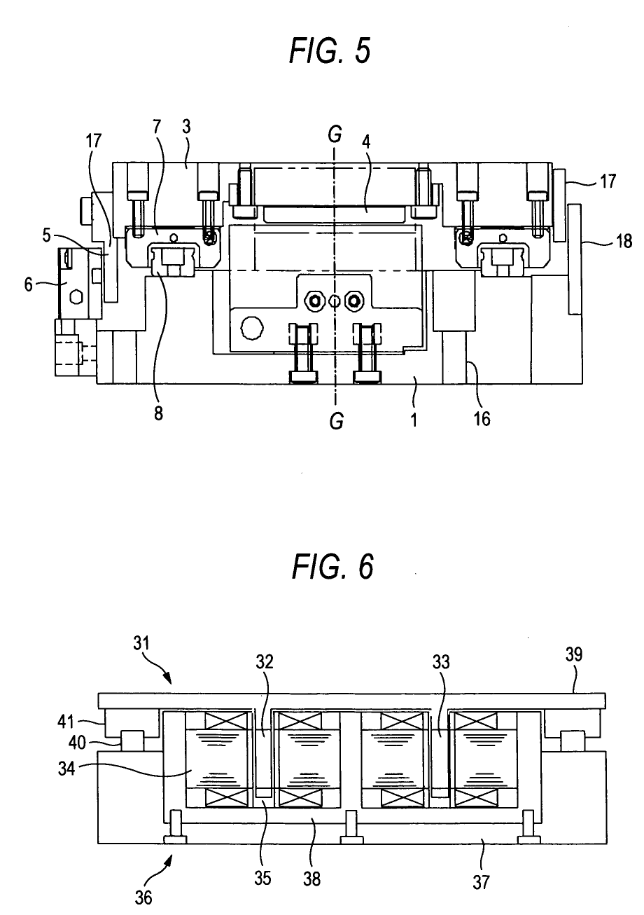

### BRIEF DESCRIPTION OF THE DRAWINGS

[FIG. 1] A plan view of a moving-magnet-type linear slider showing a first embodiment of the present invention.

[FIG. 2] A front sectional view taken along line A-A in FIG. 1.

[FIG. 3] A perspective view showing a sensor head for a linear scale according to the invention.

[FIG. 4] A plan view of a moving-magnet-type linear slider showing a second embodiment.

[FIG. 5] A front sectional view taken along line A-A in FIG. 4.

[FIG. 6] A front sectional view of a moving-magnet-type linear slider showing a conventional art.

### DESCRIPTION OF REFERENCE NUMERALS

1 Fixed base

2 Armature

3 Table

4 Permanent magnet for magnetic field

5 Linear scale

6 Sensor head

7 Slider

8 Guide rail

9 Stopper

10 Motor lead

11 Linear scale lead

12 Driver

13 Serial conversion circuit

14 Memory IC

15, 16 Mounting hole

17 Magnetic-pole-detecting magnet

18 Magnetic-pole detecting head

19 Serial converter

### BEST MODE FOR CARRYING OUT THE INVENTION

Hereinafter, embodiments of the present invention will be explained with reference to the drawings.

### EMBODIMENT 1

FIG. 1 is a plan view of a moving-magnet-type linear slider showing a first embodiment of the present invention while FIG. 2 is a front sectional view taken along line A-A in FIG. 1.

In the figure, 1 is a fixed base, 2 is an armature, 3 is a table, 4 is permanent magnet for a magnetic field, 5 is a linear scale, 6 is a sensor head, 7 is a slider, 8 is a guide rail, 9 is a stopper, 10 is a motor lead, 11 is a linear-scale lead, and 12 is a driver.

Features of the present invention are as follows.

Namely, the moving-magnet-type linear slider is basically constructed with a linear guide which movably supports and guides left and right sides of the table 3 that is arranged in parallel with and opposite to the fixed base 1, the linear guide having the slider 7 and the guide rail 8, a linear motor which reciprocally moves the table 3 along the lengthwise over the guide rails 8 relatively to the fixed base 1, and detecting means for detecting a relative position of the table 3 and the fixed base 1. The linear motor is constructed with the armature 2 having a multi-phase armature winding wire wound over an armature core serving as a magnetic circuit fixed on the fixed base 1, and a plate-formed permanent magnet 4 for a magnetic field attached on the table 3 and arranged opposite to the armature 2 interposing a magnetic gap. The detecting means is constructed with a linear scale 5 fixed on the table 3, and a sensor head 6 which detects the linear scale 5 and fixed on the fixed base 1 side.

Meanwhile, the armature 2 is arranged such that a thrust center axis where a thrust of the armature 2 is generated is placed substantially coincident with a center axis G-G of a space between the left and right guide rails 8 when fixing onto the fixed base 1 and between the left and right guide rails 8 mounted on the fixed base 1.

FIG. 3 is a perspective view showing a linear-scale sensor head according to the invention.

In FIG. 3, 13 is a serial conversion circuit and 14 is a memory IC.

The sensor head 11 incorporates a serial conversion circuit 13 which converts magnetic-pole-detection signal and scale signal of the linear motor into serial signals. Moreover, the memory 14 is provided and a motor parameter of the linear motor is input therein. When connection is provided between the linear slider and the driver 12, the motor parameter is also converted into a serial signal by the serial-signal conversion circuit 13, thus providing a contrivance to transmit a signal to the driver 12.

Meanwhile, the stoppers 9 are provided on the fixed base 1 at front and rear regions of the guide rails 8 seen in a longitudinal direction, thus preventing the table 3 from overrunning.

The operation is next explained.

As shown in FIGS. 1 and 2, when the armature of the linear motor is energized from a not-shown external power supply, the table is reciprocally moved along the longitudinal direction of the guide rails relative to the fixed base. On this occasion, when a relative position of the table and the fixed base is detected by the sensor head 6 provided on the fixed base side relative to the linear scale provided on the table side, the serial conversion circuit 13 provided in the sensor head 6, as shown in FIG. 3, serial-converts and transmits the linear-scale signal, the magnetic-pole signal and the motor parameter stored in the memory IC 14 toward the driver 12. Based on the signals and the motor parameter transmitted to the driver 12 side, an accurate positioning of the linear motor by the driver 12 is performed.

Accordingly, the moving-magnet-type linear slider according to the first embodiment of the invention is constructed by the linear guide which movably supports and guides the table 3 with respect to the fixed base 1, the linear motor in which the permanent magnet 4 for a magnetic field is arranged on the table 3 side and the armature 2 is arranged on the fixed base 1, and the detecting means in which the linear scale 5 is fixed on the table 3 and the sensor head 6 is fixed on the fixed base 1 side. Therefore, an attaching area when fixing the permanent magnet 4 for a magnetic field on the table 3 side is large, and rigidity in the thrust-generating region can be increased.

Further, arrangement is made such that, when the armature 2 is fixed to the fixed base 1 between the left and right guide rails 8 mounted on the fixed base 1, the thrust center axis where a thrust based on the armature 2 is generated is placed substantially coincident with the center axis G-G of the space between the left and right guide rails 8, thus providing a structure in which a magnetic attractive force acting upon the permanent magnet for a magnetic field is applied to the linear guide as a pressurization. Therefore, an oscillation limit can be increased when increasing the control gain for response improvement, and a high-frequency speed ripple can be reduced.

Furthermore, by arranging the leads such as the motor lead 10 and the linear scale lead 11 on the stator side from the mover, cable bear can be eliminated with respect to the moving-coil type.

Since the sensor head 11 has a structure in which the serial conversion circuit 13 which converts magnetic-pole detection signals and scale signals of the linear motor into serial signals, large-capacity transmission is available as compared to a conventional pulse transmission, thus obtaining a linear driving system that has high speed and high resolving power. Incidentally, the present embodiment can improve the minimal-positioning resolving power ten times as compared to a conventional pulse-sequence transmission.

### EMBODIMENT 2

FIG. 4 is a plan view of a moving-magnet-type linear slider showing a second embodiment of the invention while FIG. 5 is a front sectional view taken along line A-A in FIG.4.

In the first embodiment, when forming two parallel rows of mounting holes on the fixed base 1 for the user to attach onto an external apparatus, mounting holes 15 for attachment to an external apparatus are provided on outer side of the guide rails 8. However, in the second embodiment, mounting holes 16 are provided in a space between an armature side surface and the linear guide in consideration that one-side coil end width is broadened by the effect of armature coil connection processing portion.

Therefore, in the second embodiment, the width dimension of the linear slider can be reduced by providing a structure in which the mounting holes are formed in an available space between the armature and the linear guide.

### EMBODIMENT 3

FIG. 4 is a view showing a structure of a third embodiment.

In the figure, 17 is a magnetic-pole detector magnet, 18 is a magnetic-pole detector head, and 19 is a serial converter.

On an opposite side of the linear scale, a magnetic-pole detector which detects a relative position of a linear armature 12 and a permanent magnet 14 for a magnetic field is arranged, in which the magnetic detector head 18 provided with a hall element is arranged on a fixed-base 1 side, and the magnetic-pole detector magnet 17 is fixed on a table 3 side such that it is arranged to have a equal pitch as the permanent magnet 4 for a magnetic field.

A magnetic-pole detection signal is converted into a serial signal together with the scale signal output from the sensor head 16 for the linear scale by the serial converter 19, and connected and transmitted to the driver 12.

Accordingly, in the third embodiment, since the magnetic-pole detector for detecting an initial magnetic pole is provided on a slider measurer portion opposite to the linear scale, in which the detecting side (hall element) is fixed on the fixed base while the magnetic-pole sensor magnet is fixed on the table, it is possible to immediately detect a relative position of the armature and the permanent magnet for a magnetic field when turning on a servo, thus simplifying a setup.

Incidentally, it is preferable that a type in which an absolute-type encoder for detecting an absolute position signal of the mover be mounted on the linear scale described in the embodiments. This can provide a linear slider that is easy to operate in which a zero-point return operation is not necessary when turning on a power source.

### INDUSTRIAL APPLICABILITY

By thus providing a structure that is enhanced in mechanical rigidity, control performances (high-speed response, speed ripple performance) of the linear motor are improved. Therefore, it can also be applied to such as a high-speed positioning slider unit and a high-accuracy constant-feed slider unit realizing low speed ripple.

1. A moving-magnet-type linear slider comprising:
a linear guide which movably supports and guides left and right sides of a table arranged parallel with and opposite to a fixed base wherein the linear guide includes a slider and a guide rail;
a linear motor which reciprocally moves the table in a longitudinal direction over the guide rail relative to the fixed base; and
detecting means for detecting a relative position of the table and the fixed base;
characterized in that
the linear motor comprises an armature having an multi-phase armature winding wire wound on an armature core serving as a magnetic circuit fixed on the fixed base, and a permanent magnet for a magnetic field, the permanent magnet being attached on the table and arranged opposite to the armature interposing a magnetic gap,
the detecting means comprises a linear scale portion fixed to the table, and a sensor head which detects the linear scale, the a sensor head being attached on a fixed base side, and
the armature is arranged such that a thrust center axis where a thrust of the armature is generated is substantially coincident with a center axis of a space between the left and right guide rails.

2. The moving-magnet-type linear slider according to claim 1, characterized in that the moving-magnet-type linear slider further comprises:
a magnetic-pole detector which detects a relative position of the armature and the permanent magnet for a magnetic field arranged on an opposite side of the linear scale, wherein the magnetic-pole detector includes a hall element fixed on the fixed base side, and a magnetic-pole detector fixed on the table side so as to have an equal pitch as the permanent magnet for a magnetic field.

3. The moving-magnet-type linear slider according to claim 1, characterized in that the fixed base is provided with a mounting hole for attaching the moving-magnet-type linear slider to an external apparatus, wherein the mounting hole is formed in a position outside or inside of the guide rail.

4. The moving-magnet-type linear slider according to claim 1, wherein the sensor head includes a serial-signal conversion circuit which converts a scale signal of the linear motor output from the detecting means into a serial signal.

5. The moving-magnet-type linear slider according to claim 4, characterized in that the sensor head has a memory into which a motor parameter of the linear motor is input, wherein, when the linear slider and a driver are connected together, the motor parameter is also converted into a serial signal by the serial-signal conversion circuit, and the serial signal is transmitted to the driver.

6. The moving-magnet-type linear slider according to claim 1, characterized in that the linear scale mounts thereon an absolute-type encoder which detects an absolute position signal of the linear-motor mover.

7. The moving-magnet-type linear slider according to claim 2, characterized in that the moving-magnet-type linear slider further comprises a serial converter which converts a scale signal of the linear motor output from the detecting means and a magnetic-pole detection signal output from the magnetic-pole detector into serial signals.

8. The moving-magnet-type linear slider according to claim 7, wherein the sensor head has a memory into which a motor parameter of the linear motor is input, wherein, when the linear slider and a driver are connected together, the motor parameter is also converted into a serial signal by the serial converter, and the serial signal is transmitted to the driver.
